(19) United States
(12) Patent Application Publication
(10) Pub. No.: US 2004/0184865 A1
(43) Pub. Date: Sep. 23, 2004

(54) Retractable dispenser for fluid materials

(76) Inventor: Craig David Carroll, Anaheim Hills, CA (US)

Correspondence Address: Mr. Craig Carroll, 1210 Night Star Way, Anaheim Hills, CA, 92808, US

(21) Appl. No.: 10/796,492

(22) Filed: Mar. 9, 2004

Related U.S. Application Data
(60) Provisional application No. 60/453,915, filed on Mar. 13, 2003.

(51) Int. Cl. B43K 5/16; A45D 40/26

(52) U.S. Cl. 401/107; 401/117

(57) ABSTRACT

This invention provides a capless retractable cosmetic dispenser applicable to all types of cosmetic fluids and capable of self-sealing and substantially preventing vapor fluid from evaporating through the valve when the applicator is in the retracted position. The retractable dispenser includes a front cowling with an opening to allow the applicator to move in and out of the opening. Adjacent to the opening and within the front cowling is a valve capable of moving linearly within the front cowling. The valve substantially seals the cosmetic fluid and applicator from outside air and the release of vapor pressure from within the valve when the applicator is in a retracted position.

### CROSS-REFERENCE TO RELATED APPLICATION

This application claims the benefit of Provisional Patent Application No. 60/453,915 Filed Mar. 13, 2003, entitled “Retractable Dispenser For Fluid Materials.”

### BACKGROUND OF THE INVENTION

The present invention is in the field of dispensers for fluid materials such as cosmetic products, and more particularly, to dispensers for products having a semi-liquid or paste-like form such as mascara or lip moisturizer, wherein the dispenser includes a retractable applicator stored within a seal that provides a reservoir for the fluid material that the user will apply.

Existing mascara and lip moisturizer dispensers include a container that holds the cosmetic fluid, a wiper, an applicator that is attached to a spindle, and a screw tight closure cap that the rod and applicator are attached to. In use, the screw tight closure cap is removed from the container; upon removal of the cap the applicator collects fluid as it passes through the container. The applicator then passes through the wiper and opening of the container to the exterior where it can be applied. To store the applicator it is returned through the container opening and past the wiper, where the applicator can be recoated with fluid from the container reservoir. Thus, existing mascara and lip moisturizer applicators generally require two free hands to operate and tightly sealing caps to minimize the cosmetic fluids exposure to air. Failure to replace the cap tightly from this type of dispenser causes the cosmetic fluid to evaporate, which dries up the mascara or lip moisturizer after a short time. An example of a conventional mascara dispenser is disclosed in Sheffler, et al., U.S. Pat. No. 5,875,791.

The wiper functions to control the quantity of mascara or lip moisturizer that is coated on the applicator from the container reservoir. The wiper includes an aperture dimensioned less than the diameter of the applicator. As the applicator is passed through the wiper aperture, excess fluid is pulled off the applicator and returned to the container. The aperture is usually larger than the spindle to allow easy removal from the container. This often results in the spindle becoming coated with cosmetic fluid as it is removed from the container. The exterior side of the wiper also becomes coated with excess cosmetic fluid dragged out by the spindle from the container. This condition is messy and can cause the cosmetic fluid to come in contact with the hands and face.

The conventional mascara dispensers thus far described include two separate components, a container that holds the cosmetic fluid and a cap with an applicator attached to a spindle that is affixed to the cap. To apply the cosmetic fluid it requires two hands, one to unscrew the cap and the second to hold the container securely. The use of two free hands to apply the cosmetic fluid may be undesirable to the user if they only have one free hand.

There is known from U.S. Pat. No. 6,371,129, a mascara dispenser that addresses some of aforementioned disadvantages of the known mascara dispensers. The mascara dispenser of Le Bras-Brown includes an internal reservoir for receiving a quantity of cosmetic material, an elongated cylindrical shell having a closed end and an open end. A slider device attached to the post that is fitted with an applicator, having a portion of the slider accessible by the user. By manipulation of the slider device, the applicator may be projected from the dispenser for use and retracted for storage. A closure member at one end of the dispenser may be open and closed by manual manipulation or automatically by coupling to the slider device.

There is also known form Kingsford, U.S. Pat. No. 4,687,364, a mascara dispenser that also addresses some of the aforementioned disadvantages of the known mascara dispensers. The mascara dispenser of Kingsford includes an elongated cylindrical container, open at one end, which provides therein a mascara reservoir having an opening. The container due to its elongated nature, also functions as a mascara applicator handle. A wiper for the mascara brush is mounted in the reservoir opening. The brush is attached to an elongated shaft for movement through the wiper between a position inside the reservoir and a position exterior to the container. A compression spring is positioned within the reservoir about a portion of the shaft. A protrusion from the shaft that is greater than the wiper opening prevents the applicator rod from becoming detached from the reservoir when the applicator is in the protracted position.

A cap for covering the opening of the container wherein the cap contains a pin to push the brush through the wiper opening into its position in the reservoir and simultaneously close the opening in the wiper. When the cap is removed the brush is released to move through the wiper to its position outside the reservoir.

Prior art cosmetic dispensers have included slider devices for cosmetic dispensers. An example of such prior art is U.S. Pat. No. 6,371,129. However, certain deficiencies of prior art cosmetic dispensers are recognized. One such deficiency is that the dispenser requires two operations to extend the brush, the first operation requires the rotation of the closure member, and the second operation requires the sliding longitudinally of the slider. Another limitation is the assembly of prior art cosmetic dispensers appears complex, requires adhesives to secure parts, and is relatively unsuitable to high volume manufacturing processes. Therefore, it is an object of the present invention to provide an improved cosmetic dispenser.

Notwithstanding these known dispensers, there is still the need for further improvements in cosmetic dispensers for fluid materials, and particularly, mascara and lip moisturizer that overcomes the aforementioned disadvantages resulting from the construction and use of the known cosmetic dispensers.

### BRIEF SUMMARY OF THE INVENTION

The present invention is intended to provide a capless retractable cosmetic dispenser applicable to all types of cosmetic fluids and capable of self-sealing and substantially preventing vapor fluid from evaporating through the enclosure member when the applicator is in the retracted position. The retractable dispenser includes a front cowling with an opening to allow the applicator to move in and out of the opening. Adjacent to the front opening and within the front cowling is a valve capable of moving linearly within the front cowling. The valve substantially seals the cosmetic fluid and applicator from outside air and the release of vapor pressure from within the valve when the applicator is in a retracted position. The dispenser also includes a rear cowling with a rear opening. Disposed within the rear opening is a plunger that is adapted to move back and forth axially. When the plunger is forced into the rear opening the applicator is protracted through the front cowling opening, there is provided a mechanism for locking the applicator against the urging force of a compression spring so as to hold the applicator in the applying state, the mechanism unlocks the applicator when the plunger is forced further into the rear opening and the applicator is retracted back into the valve for storage. The front cowling incorporates a pre-opener that forces the front end of the valve open when the valve is forced upon the pre-opener by the forward movement of the plunger. The pre-opener also acts as a wiper system to remove a measurable amount of fluid from the applicator as it passes through the pre-opener. The valve is forced off the pre-opener by a compression member after the applicator has been retracted back into the valve. An applicator and fluid are stored within the valve. The valve includes a front end and a back end, where the front end is adapted to open to allow the applicator to extend there through. To open the front end may have a concave configuration or profile with a slit. The front end may have a planner or convex configuration or profile with a slit. To enhance proper closure of the slit, a tension device may be provided around the front end to substantially seal the slit when the applicator is in the retracted position. The back end has a hole adapted to substantially seal around the rod that the applicator is attached to. In the retracted position, the applicator is between the front and back ends to substantially seal the fluid and applicator from the outside air, and to prevent the release of vapor pressure from within the valve, thereby eliminating the need for a cap.

With capped cosmetic dispensers the fluid from within the container will evaporate into the container and the enclosure of the cap. Some of the molecules from the evaporated fluid will be reabsorbed and returned to a fluid state. Some of the molecules that make up the evaporated fluid will condense within the container and enclosure of the cap until equilibrium is reached and the container and enclosure are saturated. The pressure within the container and enclosure of the cap when saturated can range from 0 to 3 pounds per square inch. If the capped cosmetic dispenser is not sealed to withstand a pressure level of 0 to 3 pounds per square inch, the evaporated fluid from within the container and enclosure of the cap will evaporate into the atmosphere. If the material used to fabricate the container and cap is permeable, the evaporated fluid will pass through the material and into the atmosphere.

To solve the above mentioned problem, a capless retractable cosmetic dispenser is provided comprising a valve having a front end and a back end that substantially seals the fluid and applicator from outside air, and prevents the release of vapor pressure from within the valve when the applicator is in a retracted position. The valve of the present invention may be made from a material that is impermeable to outside air and vapor fluid. The valve may be treated by a secondary process known as fluorination, whereby the valve is introduced the element fluorine to further reduce or eliminate permeation of vapor fluid. The valve may be made of a material that is durable so that the slit will not wear out after the pre-opener is moved in and out many times.

Other systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

The present invention disclosed herein provides a self-sealing and linearly moving valve and dispenser that allows for one hand operation, by push button, to retract and protract an applicator stored within the dispenser. The invention incorporates a pre-opener, wiper and cowling in one complete component. Other configuration incorporating the pre-opener and wiper as a separate component attached to the cowling will become apparent to one with skill in the art upon examination of the figures and detailed description. It is intended that all such additional systems, methods, features, and advantages be included within this description, be within the scope of the invention, and be protected by the accompanying claims.

This design is simple to manufacture and assemble, enabling high volume, low-cost manufacturing. These are requirements to be a competitive and saleable product in the market. In addition, the design has the enhanced feature and added value, to the end consumer, of being capless, self-sealing and relatively inexpensive to manufacture, and thus purchase.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a cross-sectional view of a retractable dispenser in the retracted state constructed in accordance with one embodiment of the present invention showing its component parts in operative assembled relationship.

FIG. 2 is a cross-sectional view of a retractable dispenser in the protracted state constructed in accordance with one embodiment of the present invention showing its component parts in operative assembled relationship.

FIG. 3 illustrates a retractable dispenser that is disassembled.

FIG. 4 illustrates an enlarged cross sectional view of the valve in relation to the front cowling in a retracted position.

FIG. 5 illustrates a side view of the retractable dispenser in a protracted state.

FIG. 6 illustrates a side view of the retractable dispenser in a retracted state.

FIG. 7 is a front perspective view of a valve.

FIG. 8 is an enlarged cross sectional view of a valve forced over a pre-opener.

FIG. 9 is a cross sectional view of a valve.

FIG. 10 is a perspective view of a valve having a recess around the front end adapted to receive a tension device.

FIG. 11 is a perspective view of a tension device.

FIG. 12 is a perspective view of a valve having a planner face and a tension device around the front end.

FIG. 13 is a cross sectional view of a valve constructed from three separate components.

FIG. 14 illustrates a valve disassembled.

FIG. 15 is a back perspective view of a valve.

### DETAILED DESCRIPTION OF THE INVENTION

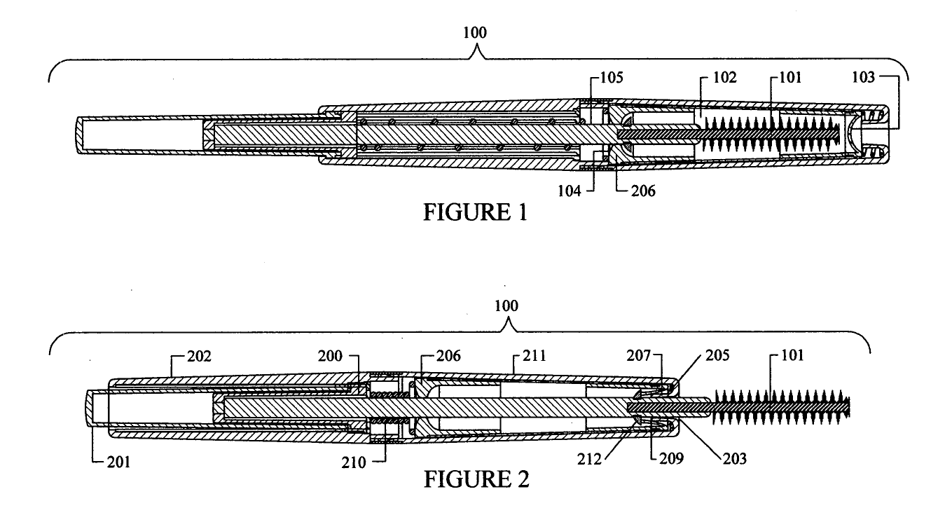

FIG. 1 illustrates the cross-sectional view of the retractable dispenser 100 in a retracted position. In the retracted position, the applicator 101 is within the enclosure 102 with the front end 103 of valve 206 substantially forming a seal, and the back end 104 of valve 206 substantially forming a seal around the rod 105. The enclosure 102 stores the fluid material that the applicator 101 comes in contact with, when the applicator is within the enclosure 102. In the retracted position, as the cosmetic fluid evaporates from the enclosure 102, the vapor is substantially sealed within the enclosure 102.

FIG. 2 illustrates the cross sectional view of the retractable dispenser 100 in the protracted position. The retractable dispenser 100 includes a front cowling 211 that holds a valve 206, a gear 200 that works with the plunger 201 and the rear cowling 202 to lock the plunger 201 and gear 200 in the retracted position or the protracted position. To extend the applicator 101 outside the opening 203, the plunger 201 is activated or pushed towards the rear cowling 202. This causes the valve 206 within the front cowling 211 to move towards opening 203 compressing compression member 205, valve 206 continues to move toward pre-opener 207 until slit 208 is forced over pre-opener 207, the applicator 101 passes through the wiper 209 and through the opening 203. The compression spring 210 resist against the pushing force until the gear 200 engages and locks in the protracted position. The applicator 101 is now ready for the user to apply the fluid. In use, the applicator 101 removes a portion of the fluid material within enclosure 102 each time the applicator 101 is protracted. It is therefore a tendency of applicator 101 to form a hollow cavity within enclosure 102 that will be devoid of the fluid material, particularly when of a paste-like consistency such as mascara and lip moisturizer. In order to keep the fluid material within enclosure 102 in contact with applicator 101, it is desirable to have the applicator 101 rotate within the enclosure 102 each time the retractable dispenser 100 is retracted and protracted. This desired rotation is accomplished by the protraction and retraction mechanisms. In addition, each time the applicator 101 is protracted and retracted, fluid movement member 212 attached to rod 105 moves fluid material to areas devoid of fluid material within enclosure 102. This movement of fluid material by the fluid movement member 212 within enclosure 102 allows the fluid material to remain in contact with the applicator 101.

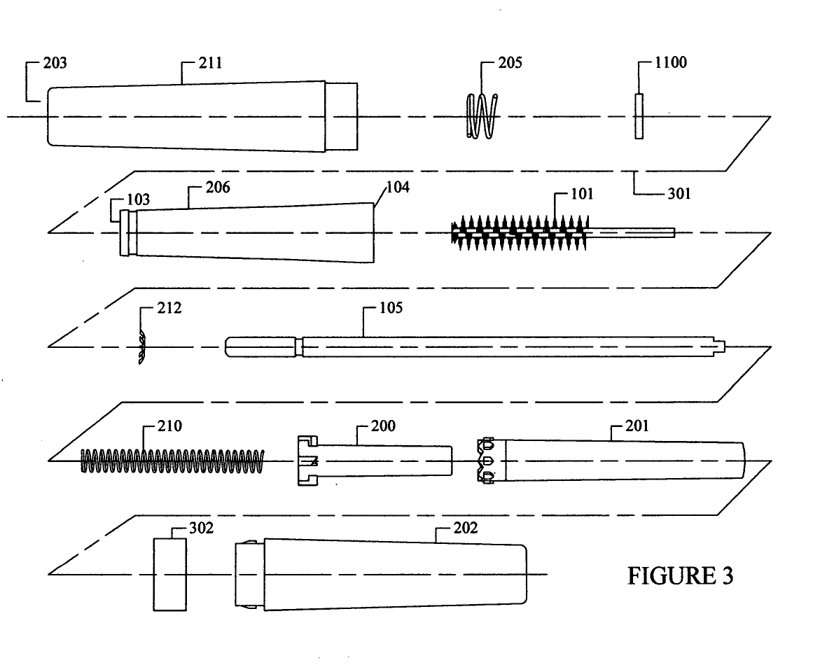

FIG. 3 illustrates the interior components of the retractable dispenser 100. The retractable dispenser 100 includes a compression member 205, a tension device 1100, a fluid movement member 212, a compression spring 210, a gear 200, a plunger 201, a cover 302, and a rear cowling 202. In addition, the retractable dispenser includes a valve 206 adapted to fit within the front cowling 211 adjacent to the pre-opener 207. The valve 206 has a front end 103 and a back end 104 forming an enclosure 102 within the valve 206. The enclosure 102 is adapted to receive the applicator 101 to substantially seal the applicator 101 from the outside air and prevent the release of vapor pressure from within the enclosure 102 when the applicator 101 is in a retracted position. The applicator 101 is coupled to a rod 105 along a longitudinal axis 301. The applicator 101 may be in the nature of a twisted-in-wire-brush, miniature comb, preformed swab, sponge applicator, flocked applicator and the like.

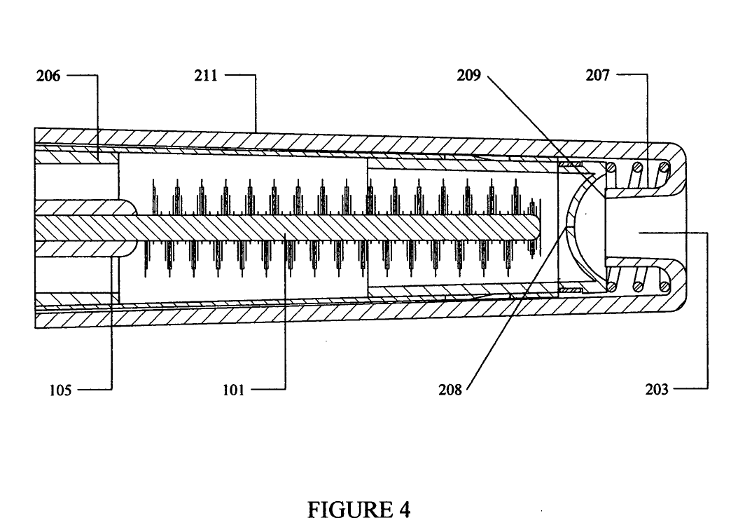

FIG. 4 illustrates an enlarged cross sectional view of the valve 206 in relation to the front cowling 211 in the retracted position. The front cowling 211 also includes a wiper 209 incorporated into the pre-opener 207. The wiper 209 is provided with an opening 203, the opening 203 is dimensioned to be generally smaller than the size of the applicator 101. The wiper 209, as is well known in the art of cosmetic dispensers, functions to remove excess cosmetic fluid from the applicator 101 as the applicator 101 moves through the opening 203. In accordance with the preferred embodiment, the opening 203 in the wiper 209 is also sized in conjunction with the rod 105 to provide close tolerance there between, while allowing relative free sliding movement of the rod 105 through the opening 203. In addition, the engagement of the wiper 209 with the rod 105 will create a seal when the dispenser is in the protracted state.

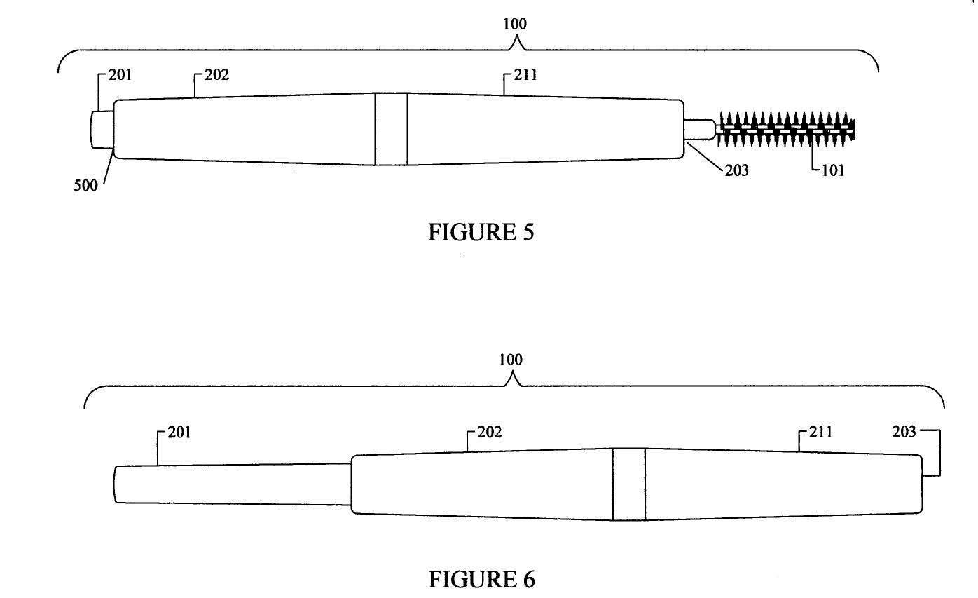

FIG. 5 illustrates a retractable dispenser 100 in a protracted position with an applicator 101 extending from the front cowling 211. The front cowling 211 has an opening 203 to allow the applicator 101 to move between a protracted position and a retracted position. The retractable dispenser 100 also has a rear cowling 202 with a rear opening 500 at the back end to allow a plunger 201 to extend between the protracted position and the retracted position. In the protracted position, the plunger 201 is pressed down relative to the rear barrel 202 that causes the applicator 101 to extend through the opening 203 and extend from the front cowling 211.

FIG. 6 illustrates the retractable dispenser 100 in a retracted position where the applicator 101 is inside the front barrel 211. In the retracted position, the plunger 201 further extends from the rear barrel 202 that causes the applicator 101 to retract into the front cowling 211 by moving back into the opening 203. As such, by activating the plunger 201 between the retracted and protracted positions, the applicator 101 is moved correspondingly between the retracted and protracted positions as well.

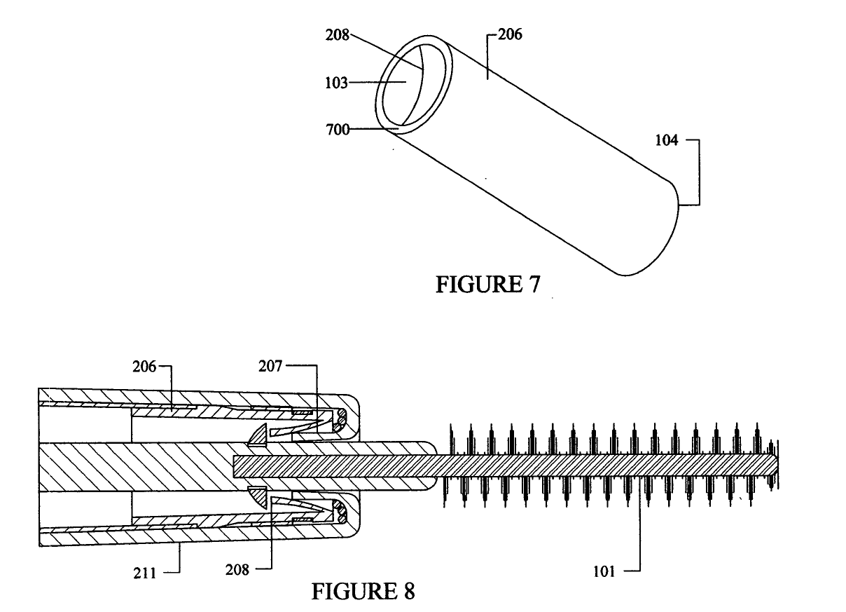

FIG. 7 illustrates a perspective view of the valve 206 with the front end 103 and the back end 104. The front end 103 may have a concaved shape profile with a slit 208 that opens to allow the pre-opener 207 to enter. The concave shape profile provides support around the slit 208 to enhance proper closure of the slit 208 when the applicator 101 moves back into the valve 206. The width of the slit 208 may extend from edge to edge of the circumference 700. In this example, the circumference 700 of the front end 103 may be circular.

FIG. 8 illustrates an enlarged cross sectional view of the front cowling 211 with the valve 206 forced over pre-opener 207, the applicator 101 extended past the front end 103 and through the slit 208. The valve 206 may be made of a material that is durable and flexible so that the slit 208 will not wear out after many cycles of the pre-opener 207 moving in and out of the slit 208. The material should have low permeability to vapor and air to seal the applicator 101. The type of material used depends on the type of fluid that is used. For water-based fluids with a lower evaporation rate than an alcohol-based fluid, silicone may be used to form the valve 206, but TPE (thermoplastic elastomer), natural rubber, synthetic rubber (e.g. isoprene), and TPV (thermoplastic vulcanizate) material including butyl rubber crossed linked with polypropylene are also preferred. A variety of methods may be used to form the valve 206 such as injection molding, blow molding, extrusion molding, and other methods known to one skilled in the art.

For alcohol-based fluids with higher evaporation rate, butyl rubber and synthetic rubber (e.g. isoprene), may be compression molded or other methods known to one skilled in the art may be used to form the valve 206. Alternatively, the valve 206 may be formed from thermoplastic elastomer with thermoplastic rubber that has low permeability to vapor. In addition, the valve 206 may be formed from thermoplastic elastomer and treated with fluorine to further reduce permeation.

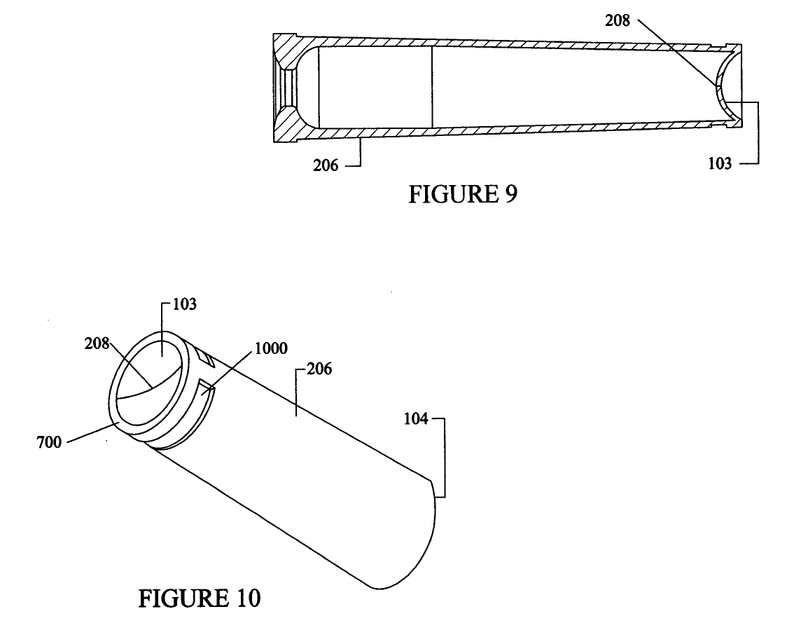

FIG. 9 illustrates a cross sectional view of a valve 206 formed from a single piece of elastomeric material. Most preferably, the radius of curvature of the front end 103 is between 0 millimeters and 4 millimeters. In addition, a further dimension that is most preferable is the thickness of the concaved shape profile of the front end 103, may be between about 0.3 millimeters and about 2 millimeters. These dimensions have been found to be very important in providing flexion of the front end 103 and opening and closing of slit 208.

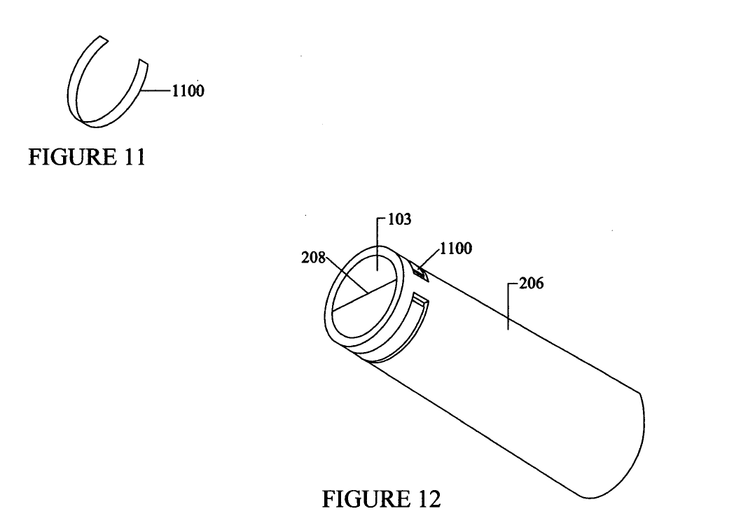

FIG. 10 illustrates a valve 206 having a recess 1000 around the front end 103 adapted to receive a tension device 1100 (FIG. 11). As the applicator 101 retracts into the enclosure 102 and the compression member 205 urges the valve 206 off the pre-opener 207, the tension device 1100 applies compression force to the slit 208 to add additional pressure to close the slit 208. A variety of tension devices may be used around the front end 103, such as an elastic band and a ring. FIG. 11 illustrates a tension device 1100 made of metal or plastic to apply compression force to the front end 103. In addition, the compression member 205 may be adapted to provide compression force to the slit 208.

With the tension device 1100, the front end 103 may have other configurations. FIG. 12 illustrates the tension device 1100 around the front end 103 having a substantially flat face.

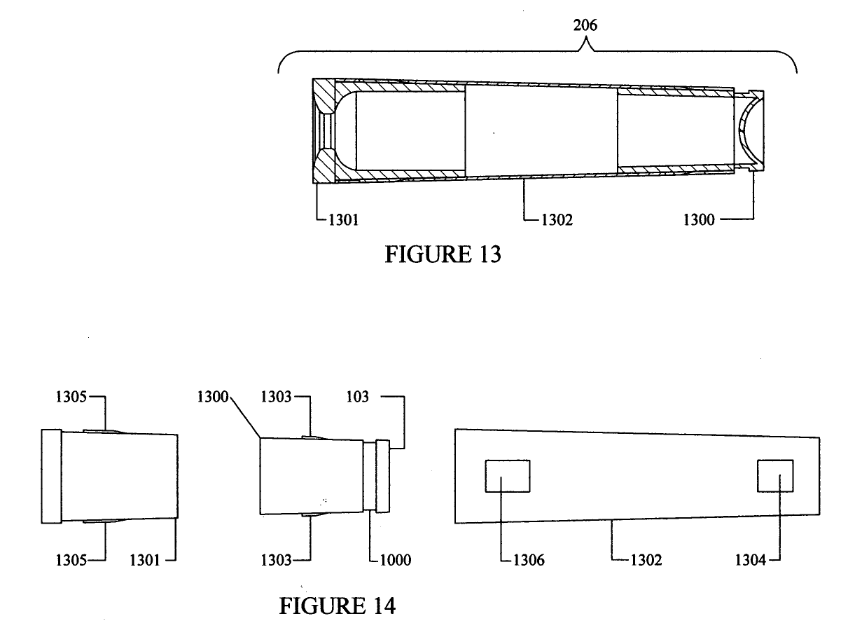

FIG. 13 is a cross sectional view of the valve 206 constructed from three separate components, the front seal 1300, rear seal 1301 and sleeve 1302.

FIG. 14 illustrates the front seal 1300 having a recess 1000 around the front end 103 adapted to receive a tension device 1100. The front seal 1300 is inserted into the sleeve 1302, where the tabs 1303 are adapted to engage with the slots 1304 in the sleeve 1302. The circumference around the front seal 1300 may be about the same or slightly greater than the inner diameter of the sleeve 1302 to form a seal. The rear seal 1301 is inserted into the sleeve 1302, where the tabs 1305 are adapted to engage with the slots 1306 in the sleeve 1302. The circumference around the rear seal 1301 may be about the same or slightly greater than the inner diameter of the sleeve 1302 to form a seal.

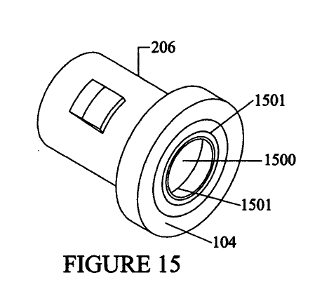

FIG. 15 illustrates the back end 104 of the valve 206. The back end 104 has a hole 1500 adapted to receive the rod 105 with the applicator 101 attached. As the applicator 101 moves between the retracted and protracted positions, the rod 105 correspondingly moves axially in and out of the hole 1500. The edges 1501 around the hole 1500 may be beveled to minimize the friction between the back end 104 and the rod 105. The rod 105 forms a seal with the back end 104. The circumference around the rod 105 may be about the same or slightly greater than the hole 1500 in the back end 104 to form a seal.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What I claim as my invention is:

1. A retractable dispenser comprising:
a front cowling (211) and a rear cowling (202) having an opening (203) and a rod (105) adapted to fit a applicator (101) capable of carrying fluid from within an enclosure (102) between a retracted position and a protracted position;
a valve (206) having a front end (103) and a back end (104), where the front end (103) has a round face with a concave shape profile and a slit (208), the front end (103) is adjacent to the opening (203) of the front cowling (211) so that in the retracted position the applicator (101) is between the front end (103) and the back end (104) substantially sealed from outside air to substantially prevent the fluid from evaporating to the outside air, and preventing the release of vapor fluid from within the enclosure (102) when the applicator (101) is in a retracted position, where in the protracted position, the applicator (101) extends through the slit (208) and past the wiper (209) and through opening (203) of the front cowling (211), where the valve (206) is made of silicone.

2. The valve (206) of claim 1, where the valve (206) is made of rubber.

3. The valve (206) of claim 1, where the valve (206) is made of thermoplastic elastomer.

4. The valve (206) of claim 3, where the valve (206) is treated with fluorine.

5. The valve (206) of claim 1, where the valve (206) is made of thermoplastic vulcanized material including rubber cross linked with polypropylene.

6. The valve (206) of claim 1, where the back end (104) has a hole (1500) that is adapted to seal around the rod (105).

7. The valve (206) of claim 1, where the front end (103) has a substantially flat profile.

8. A valve (206) including a front seal (1300) and a rear seal (1301), adapted to engage with sleeve (1302) to form a valve (206) suitable for receiving and applicator (101);
a valve (206) disposed in the front cowling (211) and adjacent to the opening (103) so that in the retracted position an applicator (101) is between the front seal (1300) and the rear seal (1301) of valve (206) substantially sealed from outside air.

9. The valve (206) of claim 8, where the front seal (1300), rear seal (1301) and sleeve (1302) define a fluid chamber.

10. The valve (206) of claim 8, where the valve (206) moves linearly and opens when forced over a pre-opener (207) and closes when urged off the pre-opener (207) by the force of a compression member (205).

11. The valve (206) of claim 8, where the valve (206) is a reservoir for the fluid.

12. The front seal (1300) of claim 8, where the front seal (1300) has at least one tab (1303) adapted to engage with at least one slot (1304) in the sleeve (1302).

13. The rear seal (1301) of claim 8, where the rear seal (1301) has at least one tab (1305) adapted to engage with at least one slot (1306) in the sleeve (1302).

14. The valve (206) of claim 8, further including a tension device (1100) around the front end (103) of the front seal (1300) to substantially close the slit (208) when the applicator (101) is in the retracted position.

15. The tension device (1100) of claim 14, where the tension device (1000) is a ring.

16. The tension device (1100) of claim 14, where the tension device (1100) is an elastic band.

17. The front seal (1300) and rear seal (1301) of claim 8, where the front seal (1300) and rear seal (1301) are made of rubber.

18. The front seal (1300) and rear seal (1301) of claim 8, where the front seal (1300) and rear seal (1301) are made of silicone.

19. The front seal (1300) of claim 8, where the front seal (1300) has a concave shape profile with a slit (208) that is formed along the longitudinal axis (301).

20. The front seal (1300) of claim 8, where the front end (103) has a substantially flat profile with a slit (208) that is formed along the longitudinal axis (301).

21. The rear seal (1301) of claim 8, where the back end (104) has a hole (1500) that is adapted to substantially seal around a rod (105).

22. A retractable dispenser (100) having a system capable of moving a valve (206) linearly within a front cowling (211) from a retracted state to a protracted state, the system comprising;
a plunger (201) forced into rear opening (500), the valve (206) compresses compression member (205), valve (206) continues to move toward pre-opener (207) until slit (208) is forced over pre-opener (207), the applicator (101) passes through a wiper (209) and through an opening (203), the gear (200) locks the rod (105) in the protracted position.

23. A retractable dispenser (100) having a system capable of moving a valve (206) linearly within a front cowling (211) from a protracted state to a retracted state, the system comprising;
a plunger (201) forced into rear opening (500), the gear (200) releases and unlocks the rod (105), the applicator (101) retracts through opening (203) and past wiper (209) into enclosure (102), compression member (205) urges valve (206) off pre-opener (207) in a retracted state.

24. The system of claim 23, where a mechanism allows for the applicator (101) to be retracted within the enclosure (102) before the valve (206) disengages from the pre-opener (207) and is closed.

25. A retractable dispenser having a valve (206) to seal an applicator (101), the valve (206) comprising;
a front end (103) and a back end (104), where the front end (103) and the back end (104) form an enclosure (102), the front end (103) having a concaved shape profile with a slit (208) that opens when forced over a pre-opener (207) to allow a applicator (101) to pass through a wiper (209) when the applicator (101) of the present invention is in a protracted position, and when the applicator (101) of the present invention is in a retracted position, the applicator (101) is within the enclosure (102);
a tension device (1100) supports the front end (103), the back end (104) forms a seal around rod (105) to substantially seal the enclosure (102) from outside air and prevent the loss of vapor fluid from escaping through the front end (103) and back end (104) of the valve (206), where the valve is made of rubber.

26. The valve (206) of claim 25, where the tension device (1100) around the front end (103) to support the closing of slit (208) to withstand between 0 and 4 pounds of vapor pressure from within the enclosure (102).

27. The tension device (1100) of claim 26, where the tension device (1100) is a ring.

28. The tension device (1100) of claim 26, where the tension device (1100) is an elastic band.

29. The valve (206) of claim 25, where the diameter of the hole (1500) is less than the diameter of the rod (105) to substantially seal the hole (1500) to withstand between 0 and 4 pounds of vapor pressure from within the enclosure (102).

30. The valve (206) of claim 25, where the front end (103) has an oval face, where the oval face has an elongated edge, where the slit (208) is formed along the longitudinal axis (301).

31. The valve (206) of claim 25, where the valve (206) is made of silicone.

32. A dispenser for fluid material, said dispenser comprising an elongated hollow outer housing including a front cowling (211) and rear cowling (202), the front cowling (211) having a pre-opener (207), wiper (209) and opening (203).

33. A mechanism for rotating the applicator (101) to pick up fluid within the enclosure (102) as the dispenser is retracted and protracted.

34. A applicator (101) attached to a rod (105) wherein the rod (105) has a fluid movement member (212) that moves fluid material to areas within the enclosure (212) that become devoid of fluid material as the dispenser is protracted and retracted.
